(19) United States
(12) Patent Application Publication
(10) Pub. No.: US 2007/0127459 A1
(43) Pub. Date: Jun. 7, 2007

(54) NETWORK APPARATUS AND METHOD FOR FORWARDING MULTICAST PACKETS FOR THE SAME

(75) Inventors: Wen-Chia Lo, Tu-Cheng,Taipei Hsien (TW); Yu-Hsin Lin, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,940

(22) Filed: May 29, 2006

(30) Foreign Application Priority Data
Dec. 3, 2005 (CN) 200510102103.X

(51) Int. Cl. H04L 12/56

(52) U.S. Cl. 370/389

(57) ABSTRACT

A network apparatus for forwarding multicast packets to a plurality of multicast receivers includes a switch and a main module. The switch includes a plurality of ports for connecting the plurality of multicast receivers. The main module includes an Internet group management protocol (IGMP) snooping module and a forwarding module. The IGMP snooping module creates several virtual local area networks (VLANs) based on the possible combinations of the plurality of ports, snoops IGMP report messages, determines port identifiers (IDs) of source ports of the IGMP report messages, and establishes a forwarding table according to the VLANs, the IGMP report messages, and the port IDs. The forwarding module adds VLAN tags to multicast packets according to the forwarding table. The switch forwards the multicast packets with the added VLAN tags to corresponding ports according to the VLAN tags. A method for forwarding multicast packets is also disclosed.

### FIELD OF THE INVENTION

The invention relates to network communications, and particularly to a network apparatus and a method for forwarding multicast packets.

### DESCRIPTION OF RELATED ART

FIG. 1 is a schematic diagram of a conventional network communication system. The network communication system includes a multicast router 10, a gateway 20, and a plurality of hosts 30, 40, and 50. The gateway 20 includes a first interface 21 and a second interface 22. The multicast router 10 is connected to the first interface 21 in a wide area network (WAN) side of the gateway 20. The hosts 30, 40, and 50 are connected to the second interface 22 in a local area network (LAN) side of the gateway 20.

The Internet group management protocol (IGMP) is a communication protocol used to manage memberships of Internet protocol (IP) multicast groups. Employing the IGMP, the hosts 30, 40, and 50 communicate with the multicast router 10 via the gateway 20, and informs the multicast router 10 that the hosts 30, 40, and 50 want to join or leave a certain multicast group. Then the multicast router 10 can establish a new multicast group membership.

The gateway 20 usually has to implement an IGMP snooping mechanism to facilitate multicast packets forwarding from the Internet to a local area network. The IGMP snooping mechanism operates at the third layer of the Internet protocol (IP) to snoop IGMP query, report, and leave messages transferred between the multicast router 10 and the hosts 30, 40, and 50, thereby learning IP multicast group memberships. That is, the gateway 20 checks the IGMP query, report, and leave messages passing through the gateway 20, and records multicast group addresses, incoming interfaces, and host addresses in a table.

In the network communication system of FIG. 1, the multicast router 10 transmits IGMP query messages to the hosts 30, 40, and 50 via the gateway 20. The hosts 30, 40, and 50 transmit IGMP report messages to the multicast router 10 via the gateway 20, in order to reply the IGMP query messages and join in multicast groups. The hosts 30, 40, and 50 can also actively send the IGMP report messages in order to join in the multicast groups. The gateway 20 can snoop the IGMP report messages from the hosts 30, 40, and 50, and establish an entry for each multicast group in a forwarding table in FIG. 2. Therefore, by inquiring of the forwarding table shown in FIG. 2, the gateway 20 can forward multicast packets of each multicast group to source interfaces of the IGMP report messages joining in the multicast group. That is, the multicast packets are forwarded to the hosts connected to the interfaces.

For example, referring to FIG. 2, only the hosts 30 and 40 join in the multicast group whose address is 239.0.0.1, and the host 50 does not join in the multicast group. However, by inquiring of the forwarding table in FIG. 2, the gateway 20 will forward multicast packets of the multicast group to the hosts 30, 40, and 50. Therefore, the host 50 will receive the multicast packets without need. This not only disturbs the host 50, but also wastes network resources.

### SUMMARY OF THE INVENTION

An aspect of the present invention provides a network apparatus that forwards multicast packets to a plurality of multicast receivers. The network apparatus includes a switch and a main module. The switch includes a plurality of ports for connecting the plurality of multicast receivers. The main module includes an Internet group management protocol (IGMP) snooping module and a forwarding module. The IGMP module creates several virtual local area networks (VLANs) based on the possible combinations of the plurality of ports, snoops IGMP report messages, determines port identifiers (IDs) of source ports of the IGMP report messages, and establishes a forwarding table according to the VLANs, the IGMP report messages, and the port IDs. The forwarding module adds VLAN tags to multicast packets according to the forwarding table. The switch forwards the multicast packets with the added VLAN tags to corresponding ports according to the VLAN tags.

Another aspect of the present invention provides a method for forwarding multicast packets. The method includes the steps of: providing a plurality of ports; creating several virtual local area networks (VLANs) based on the possible combinations of the plurality of ports; establishing a null forwarding table; snooping Internet group management protocol (IGMP) report messages; transmitting probe request messages to each port; receiving corresponding probe reply messages, and determining port identifiers (IDs) of source ports of corresponding probe reply messages; recording the port IDs in the forwarding table; determining VLAN IDs according to the port IDs and the VLANs, and accordingly updating the forwarding table; adding VLAN tags to multicast packets according to the forwarding table; and forwarding the multicast packets with the added VLAN tags to corresponding ports according to the VLAN tags.

Employing the above network apparatus and the method for forwarding multicast packets, the multicast receivers connected to the network apparatus need not receive unneeded multicast packets, so network resources are economized.

Other advantages and novel features will become more apparent from the following detailed description when taken in conjunction with the accompanying drawings, in which:

### BRIEF DESCRIPTION OF THE DRAWINGS

FIG. 1 is a schematic diagram of a conventional network communication system;

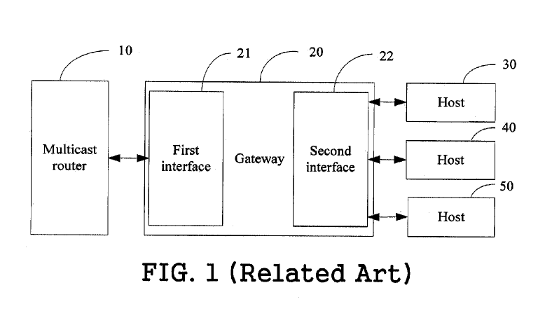

FIG. 2 is a schematic diagram of a conventional forwarding table employed by the conventional network communication system of FIG. 1;

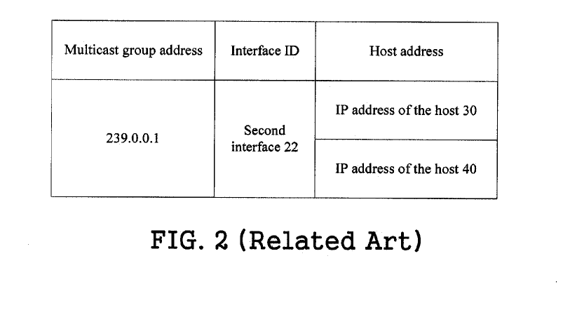

FIG. 3 is a schematic diagram of a network communication system and functional modules of a network apparatus of an exemplary embodiment of the present invention;

FIG. 4 is a schematic diagram of a VLAN table of an exemplary embodiment of the present invention;

FIG. 5 is a schematic diagram of a forwarding table of an exemplary embodiment of the present invention;

FIG. 6 is a flowchart of network communication of an exemplary embodiment of the present invention; and

FIG. 7 is a flowchart of a method for forwarding multicast packets of an exemplary embodiment of the present invention.

### DETAILED DESCRIPTION OF THE INVENTION

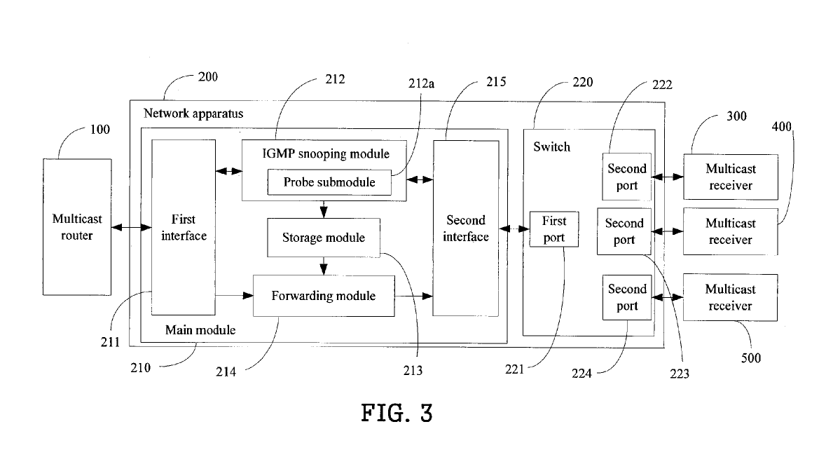

FIG. 3 is a schematic diagram of a network communication system and functional modules of a network apparatus 200 of an exemplary embodiment of the present invention. In the exemplary embodiment, the network communication system includes a multicast router 100, a network apparatus 200, and a plurality of multicast receivers 300, 400, and 500. The multicast router 100 transmits Internet group management protocol (IGMP) query messages and/or multicast packets to the multicast receivers 300, 400, and 500 via the network apparatus 200. The multicast receivers 300, 400, and 500 transmit IGMP report messages and/or IGMP leave messages to the multicast router 100 via the network apparatus 200. In the exemplary embodiment, the network apparatus 200 may be a gateway, and the multicast receivers 300, 400, and 500 may be hosts. In other embodiments, the network apparatus 200 may be a router or another network apparatus, and the multicast receivers 300, 400, and 500 may be other multicast receivers.

The network apparatus 200 is connected to the multicast router 100 and the multicast receivers 300, 400, and 500, and snoops the IGMP report messages from the multicast receivers 300, 400, and 500 to establish a forwarding table. The network apparatus 200 further forwards the multicast packets from the multicast router 100 to the multicast receivers 300, 400, and 500 according to the forwarding table. In the exemplary embodiment, the network apparatus 200 includes a main module 210 and a switch 220. The switch 220 includes a first port 221 and a plurality of second ports 222, 223, and 224. The first port 221 is connected to the main module 210. The second ports 222, 223, and 224 are respectively connected to the multicast receivers 300, 400, and 500.

The main module 210 includes a first interface 211, an IGMP snooping module 212, a storage module 213, a forwarding module 214, and a second interface 215. The first interface 211 is used for connecting the IGMP snooping module 212, the forwarding module 214, and the multicast router 100. The second interface 215 is used for connecting the IGMP snooping module 212, the forwarding module 214, and the switch 220.

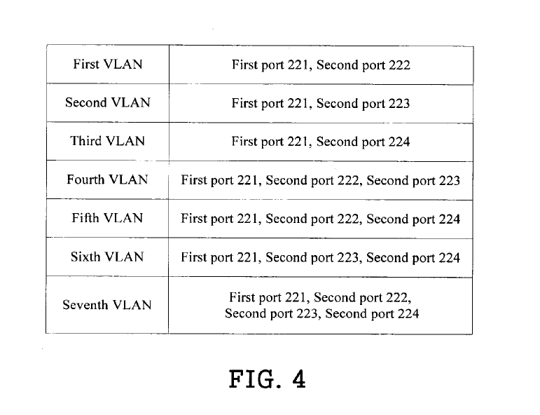

The IGMP snooping module 212 creates several virtual local area networks (VLANs) based on the possible combinations of the first port 221 with the second ports 222, 223, and 224. FIG. 4 is a schematic diagram of a VLAN table of an exemplary embodiment of the present invention. In the exemplary embodiment, the IGMP snooping module 212 creates 7 VLANs as follows: a first VLAN including the first port 221 and second port 222; a second VLAN including the first port 221 and the second port 223; a third VLAN including the first port 221 and the second port 224; a fourth VLAN including the first port 221 and the second ports 222 and 223; a fifth VLAN including the first port 221 and the second ports 222 224; a sixth VLAN including the first port 221 and the second ports 223 and 224; and a seventh VLAN including the first port 221 and the second ports 222, 223, and 224.

In other embodiments, the IGMP snooping module 212 may creates other VLANs based on the available combinations of the first port 221, the second ports 222, 223, 224 and/or other ports.

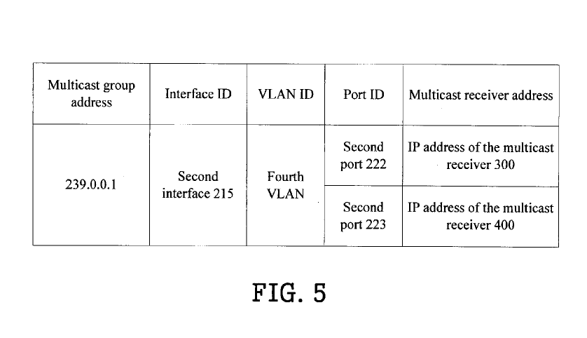

The IGMP snooping module 212 further snoops the IGMP report messages from the multicast receivers 300, 400, and 500, determines port identifiers (IDs) of source ports of the IGMP report messages, and establishes a forwarding table according to the VLANs in the VLAN table, the IGMP report messages, and the port IDs. In the exemplary embodiment, the IGMP snooping module 212 first establishes a forwarding table as shown in FIG. 5, then updates the forwarding table according to the IGMP report messages. Referring to FIG. 5, the forwarding table includes a multicast group address field, an interface ID field, a VLAN ID field, a port ID field, and a multicast receiver address field. A predetermined value of the VLAN ID field is the seventh VLAN. In the initial forwarding table, each field of the forwarding table is null or a predetermined value. The contents in the forwarding table in FIG. 5 are added or updated after being created. In the exemplary embodiment, the interface ID field may only be the second interface ID, and the port ID field may only be the second port ID.

After receiving the IGMP report messages, the IGMP snooping module 212 records corresponding information in the multicast group address field, the interface ID field, and the multicast receiver address field in the forwarding table according to the IGMP report messages. The IGMP snooping module 212 further transmits probe request messages to each port of the switch 220, and determines port IDs of source ports of corresponding probe reply messages. In the exemplary embodiment, the IGMP snooping module 212 includes a probe submodule 212a. The probe submodule 212a transmits probe request messages through the second ports 222, 223, and 224 via the second interface 215 and the first port 221 to the multicast receivers 300, 400, and 500 respectively. The source multicast receivers of the IGMP report messages must send back the corresponding probe reply messages to the probe submodule 212a via the ports connected to the source multicast receivers. In the exemplary embodiment, the probe request messages may be address resolution protocol (ARP) request messages, and the probe reply messages may be ARP reply messages.

In other embodiments, the probe request messages may be Internet control message protocol (ICMP) echo request messages, and the probe reply messages may be ICMP echo reply messages.

After the probe submodule 212a determines the port IDs of the source ports of the IGMP report messages, the IGMP snooping module 212 records the port IDs in the port ID field in the forwarding table, determines VLAN IDs according to the port IDs and the VLAN table (see in FIG. 4), and accordingly updates the VLAN ID field in the forwarding table shown in FIG. 5.

For example, referring to FIG. 5, the multicast receivers 300 and 400 join in a multicast group whose address is 239.0.0.1. The port ID of the port connected to the multicast receiver 300 can be determined to be the second port 222, and the port ID of the port connected to the multicast receiver 400 can be determined to be the second port 223, by the probe submodule 212a. Therefore, the VLAN can be determined to be the fourth VLAN according to the VLAN table in FIG. 4, and accordingly the VLAN ID field in the VLAN table is updated to be the fourth VLAN.

The storage module 213 stores the VLAN table in FIG. 4 and the forwarding table in FIG. 5. The forwarding module 214 adds VLAN tags to multicast packets according to the forwarding table. A VLAN tag is a field within a packet that identifies the packet's VLAN membership and priority. In the above example, the VLAN tag includes identification of the fourth VLAN.

The switch 220 forwards the multicast packets with the added VLAN tags to corresponding ports according to the VLAN tags. That is, the switch 220 forwards the multicast packets to multicast receivers connected to the corresponding ports. In the above example, the switch 220 forwards the multicast packets to the second ports 222 and 223, namely the multicast receivers 300 and 400. Therefore, the multicast receiver 500 need not receive the multicast packets.

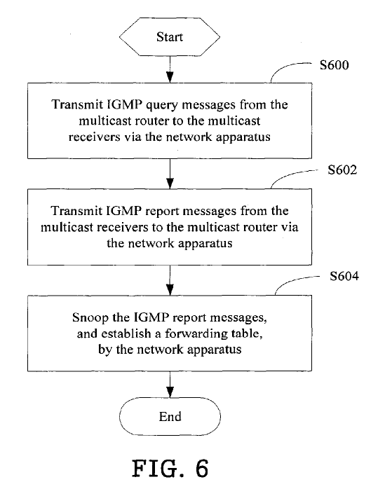

FIG. 6 is a flowchart of network communication of an exemplary embodiment of the present invention. In the exemplary embodiment, the multicast router 100 communicates with the multicast receivers 300, 400, and 500 via the network apparatus 200.

In step S600, the multicast router 100 transmits IGMP query messages to the multicast receivers 300, 400, and 500 via the network apparatus 200.

In step S602, the multicast receivers 300, 400, and 500 transmit IGMP report messages to the multicast router 100 via the network apparatus 200 after receiving the IGMP query messages.

In other embodiments, the multicast receivers 300, 400, and 500 may actively transmit the IGMP report messages to the multicast router 100.

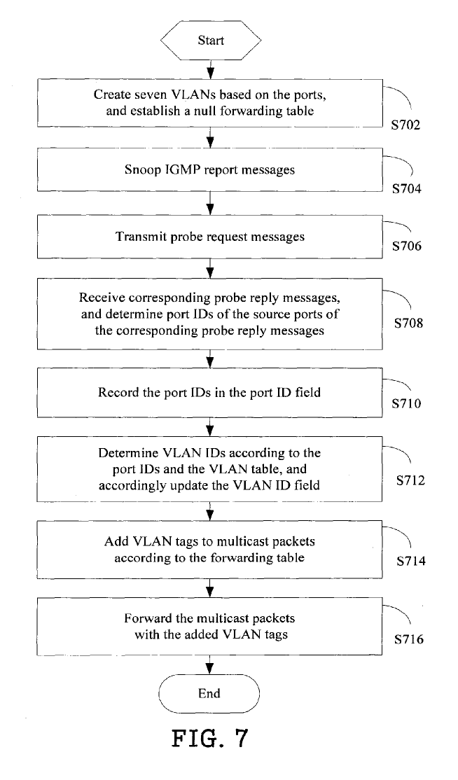

In step S604, the network apparatus 200 snoops the IGMP report messages from the multicast receivers 300, 400, and 500, and establishes a forwarding table. The details for establishing the forwarding table are described in FIG. 7.

FIG. 7 is a flowchart of a method for forwarding multicast packets of an exemplary embodiment of the present invention. In the exemplary embodiment, the network apparatus 200 forwards multicast packets from the multicast router 100 to the multicast receivers 300, 400, 500.

In step S702, the IGMP snooping module 212 of the network apparatus 200 creates seven VLANs based on the possible combinations of the first port 221 with the second ports 222, 223, and 224, and establishes a null forwarding table. Referring to FIG. 5, the forwarding table includes a multicast group address field, an interface ID field, a VLAN ID field, a port ID field, and a multicast receiver address field. The predetermined value of the VLAN ID is the seventh VLAN.

In step S704, the IGMP snooping module 212 snoops IGMP report messages. The IGMP snooping module 212 receives the IGMP report messages, and then records corresponding information in the multicast group address field, the interface ID field, and the multicast receiver address field in the forwarding table according to the IGMP report messages.

In step S706, the probe submodule 212a of the IGMP snooping module 212 transmits probe request messages through each of the second ports 222, 223, and 224 via the second interface 215 and the first port 221, to their corresponding multicast receivers 300, 400, and 500 respectively. Then corresponding probe reply messages must be sent back from the multicast receivers 300, 400, and 500 that sent the IGMP report messages via the corresponding second ports 222, 223, and 224.

Therefore, in step S708, the probe submodule 212a receives corresponding probe reply messages, and determines port IDs of the source ports of the corresponding probe reply messages.

In step S710, the IGMP snooping module 212 records the port IDs in the port ID field in the forwarding table in FIG. 5.

In the exemplary embodiment, the probe request messages may be ARP request messages, and the probe reply messages may be ARP reply messages. In other embodiments, the probe request messages may be ICMP echo request messages, and the probe reply messages may be ICMP echo reply messages.

In step S712, the IGMP snooping module 212 determines VLAN IDs according to the port IDs and the VLAN table, and accordingly updates the VLAN ID field in the forwarding table.

In step S714, the forwarding module 214 adds VLAN tags to multicast packets from the multicast router 100 according to the forwarding table. The VLAN tags include VLAN IDs.

In step S716, the switch 220 forwards the multicast packets with the added VLAN tags through corresponding ports to multicast receivers according to the VLAN tags.

In the embodiment of the present invention, the multicast packets are accurately forwarded through specific ports to their corresponding multicast receivers, so other ports/multicast receivers do not receive the multicast packets without need. Therefore, network resources are economized.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A network apparatus for forwarding multicast packets to a plurality of multicast receivers, comprising:
a switch comprising a plurality of ports for connecting the plurality of multicast receivers; a main module, comprising:
an Internet group management protocol (IGMP) snooping module, for creating several virtual local area networks (VLANs) based on the possible combinations of the plurality of ports, snooping IGMP report messages, determining port identifiers (IDs) of source ports of the IGMP report messages, and establishing a forwarding table according to the VLANs, the IGMP report messages, and the port IDs; and
a forwarding module for adding VLAN tags to multicast packets according to the forwarding table;
wherein the switch further forwards the multicast packets with the added VLAN tags to corresponding ports according to the VLAN tags.

2. The network apparatus as claimed in claim 1, wherein the IGMP snooping module comprises a probe submodule, for transmitting probe request messages to each port and determining port IDs of source ports of corresponding probe reply messages.

3. The network apparatus as claimed in claim 2, wherein the probe request messages are address resolution protocol (ARP) request messages, and the probe reply messages are ARP reply messages.

4. The network apparatus as claimed in claim 2, wherein the probe request messages are Internet control message protocol (ICMP) echo request messages, and the probe reply messages are ICMP echo reply messages.

5. The network apparatus as claimed in claim 1, wherein the forwarding table comprises a port ID field and a VLAN ID field.

6. The network apparatus as claimed in claim 5, wherein the forwarding table further comprises a multicast group address field, an interface ID, and a multicast receiver address field.

7. The network apparatus as claimed in claim 6, wherein the IGMP snooping module is further used for recording corresponding information in the multicast group address field, the interface ID field, and the multicast receiver address field in the forwarding table according to the IGMP report messages.

8. The network apparatus as claimed in claim 1, further comprising a storage module, for storing the VLANs and the forwarding table.

9. The network apparatus as claimed in claim 1, further comprising a plurality of interfaces, for connecting the IGMP snooping module, the forwarding module, and the switch.

10. A method for forwarding multicast packets, comprising the steps of:
providing a plurality of ports;
creating several virtual local area networks (VLANs) based on the possible combinations of the plurality of ports;
establishing a null forwarding table;
snooping Internet group management protocol (IGMP) report messages;
transmitting probe request messages to each port;
receiving corresponding probe reply messages, and determining port identifiers (IDs) of source ports of the corresponding probe reply messages;
recording the port IDs in the forwarding table;
determining VLAN IDs according to the port IDs and the VLANs, and accordingly updating the forwarding table;
adding VLAN tags to multicast packets according to the forwarding table; and
forwarding the multicast packets with the added VLAN tags to corresponding ports according to the VLAN tags.

11. The method as claimed in claim 10, wherein the probe request messages are address resolution protocol (ARP) request messages, and the probe reply messages are ARP reply messages.

12. The method as claimed in claim 10, wherein the probe request messages are Internet control message protocol (ICMP) echo request messages, and the probe reply messages are ICMP echo reply messages.

13. The method as claimed in claim 10, wherein the forwarding table comprises a port ID field and a VLAN ID field.

14. The method as claimed in claim 13, wherein the forwarding table further comprises a multicast group address field, an interface ID field, and a multicast receiver address field.

15. The method as claimed in claim 14, further comprising a step of recording corresponding information in the multicast group address field, the interface ID field, and the multicast receiver address field in the forwarding table according to the IGMP report messages.
